(19) United States
(12) Patent Application Publication
(10) Pub. No.: US 2026/0160938 A1
(43) Pub. Date: Jun. 11, 2026

(54) DISPLAY APPARATUS

(71) Applicant: LG Display Co., Ltd., Seoul (KR)

(72) Inventors: Min Jin LEE, Paju-si (KR); Jin Ryun KIM, Paju-si (KR); Ji Gon KIM, Paju-si (KR); Dae Yong KIM, Paju-si (KR); Eun Hee CHOI, Paju-si (KR)

(73) Assignee: LG Display Co., Ltd., Seoul (KR)

(21) Appl. No.: 19/402,549

(22) Filed: Nov. 26, 2025

(30) Foreign Application Priority Data
Dec. 10, 2024 (KR) 10-2024-0183060

(51) Int. Cl. F21V 8/00

(52) U.S. Cl. CPC G02B 6/0088; G02B 6/0035

(57) ABSTRACT

Disclosed is a display apparatus including a backlight unit including a backlight light guide plate, a plurality of backlight sheets located on a front surface of the backlight light guide plate, the backlight sheets having sheet holes respectively formed therein, and a backlight light source element configured to emit light to the backlight light guide plate, a liquid crystal panel located on a front surface of the backlight unit, and an optical module located on a portion of a back surface of the backlight unit, the portion overlapping the plurality of sheet holes, the optical module being configured to detect external light incident through the sheet holes. A sheet hole guide part configured to align the plurality of sheet holes is inserted into the plurality of sheet holes.

This application claims the priority benefit of Korean Patent Application No. 10-2024-0183060, filed on Dec. 10, 2024, which is hereby incorporated by reference as if fully set forth herein.

### BACKGROUND

### Technical Field

The present disclosure relates to an apparatus and particularly to, for example, without limitation, a display apparatus.

### Discussion of the Related Art

In general, a display apparatus provides an image to a user. For example, the display apparatus may include a backlight unit and a liquid crystal panel that generates an image using light provided from the backlight unit. The backlight unit may include a backlight light source element located on one side surface of a backlight light guide plate. The liquid crystal panel may be located on the backlight light guide plate.

The display apparatus may include a light source module for detection of external light. For example, the light source module may include an IR camera sensor. The light source module may overlap a partial area of the liquid crystal panel. For example, the liquid crystal panel may include an active area overlapping the backlight light guide plate and a hole area overlapping the light source module.

The hole area may be disposed within the active area. However, the hole area of the liquid crystal panel does not emit light for image implementation, and boundary lines of sheet holes respectively formed in backlight sheets, which form a camera hole, appear as a plurality of boundary lines in a state of overlapping each other on the screen of the liquid crystal panel, and the boundary lines are visually recognized by a user. As a result, in the display apparatus, the quality of an image provided to a user and front-of-screen (FOS) quality may deteriorate.

### SUMMARY

Accordingly, embodiments of the present disclosure are directed to a display apparatus that substantially obviates one or more problems due to limitations and disadvantages of the related art.

An aspect of the present disclosure is to provide a display apparatus including an optical module.

Another aspect of the present disclosure is to solve a problem in which a boundary line of a camera hole in a hole area appears as a plurality of boundary lines in a state of overlapping each other on the screen of a liquid crystal panel and the boundary lines are visually recognized by a user.

Still another aspect of the present disclosure is to improve image quality (front-of-screen (FOS) quality) characteristics of an image displayed in a hole area of a liquid crystal panel.

Additional features and aspects will be set forth in the description that follows, and in part will be apparent from the description, or may be learned by practice of the inventive concepts provided herein. Other features and aspects of the inventive concepts may be realized and attained by the structure particularly pointed out in the written description, or derivable therefrom, and the claims hereof as well as the appended drawings.

To achieve these and other aspects of the inventive concepts, as embodied and broadly described herein, a display apparatus comprises a backlight unit including a backlight light guide plate, a plurality of backlight sheets located on a front surface of the backlight light guide plate and having sheet holes respectively, and a backlight light source element configured to emit light to the backlight light guide plate, a liquid crystal panel located on a front surface of the backlight unit, and an optical module located on a back surface of the backlight unit and overlapped with the plurality of sheet holes, the optical module being configured to detect external light incident through the sheet holes, wherein a sheet hole guide part configured to align the plurality of sheet holes is inserted into the plurality of sheet holes.

The sheet hole guide part may have an end adjacent to the liquid crystal panel, the end being located in a separation space formed between the plurality of backlight sheets and the liquid crystal panel.

Planar shapes of the plurality of sheet holes may be correspond to each other, and the sheet hole guide part may have a planar shape corresponding to the planar shape of each of the plurality of sheet holes.

The sheet hole guide part may be integrally provided with a part of the backlight light guide plate and may be formed to protrude from the backlight light guide plate so as to be inserted into the plurality of sheet holes.

The backlight light guide plate may include a light guide plate pattern configured to refract or diffuse the light incident from the backlight light source element in a predetermined direction, and the light guide plate pattern may not be provided at a portion of the backlight light guide plate, the portion overlapping the sheet hole guide part, but may be provided at a portion of the backlight light guide plate, the portion not overlapping the sheet hole guide part.

The sheet hole guide part may have a transmittance equal to a transmittance of a portion of the backlight light guide plate, the portion overlapping the sheet holes.

A protrusion length of the sheet hole guide part may be larger than a sheet thickness obtained by summing thicknesses of the plurality of backlight sheets and may be smaller than the sum of a separation space formed between the plurality of backlight sheets and the liquid crystal panel and the sheet thickness.

The sheet hole guide part may be formed of a material identical to a material of the backlight light guide plate.

The backlight light guide plate may include a light guide plate hole formed in a portion where the plurality of sheet holes overlap, and the sheet hole guide part may be inserted into the plurality of sheet holes and the light guide plate hole.

The backlight light guide plate may include a light guide plate pattern configured to refract or diffuse the light incident from the backlight light source element in a predetermined direction, and the sheet hole guide part may not include the light guide plate pattern.

The sheet hole guide part may have a transmittance of 85% or more in a wavelength band ranging from 400 nm to 950 nm.

A thickness of the sheet hole guide part may be larger than a sum thickness of a sheet thickness obtained by summing thicknesses of the plurality of backlight sheets and a thickness of the backlight light guide plate and may be smaller than a sum of a separation space formed between the plurality of backlight sheets and the liquid crystal panel and the sum thickness.

The sheet hole guide part may be formed of a material identical to or different from a material of the backlight light guide plate and may include any one of glass, plastic, acrylic, polymethylmethacrylate (PMMA), and polycarbonate (PC).

A ratio of a width of the plurality of sheet holes to a width of the sheet hole guide part may range from 1:0.94 to 1:0.99.

The plurality of sheet holes and the sheet hole guide part may be spaced apart from each other by a first interval, and a ratio of a width of the plurality of sheet holes to the first interval may range from 1:0.04 to 1:0.01.

The optical module may include a module light guide plate provided on a back surface of the backlight light guide plate and located to overlap the sheet holes, the module light guide plate being configured to guide auxiliary light received from a module light source provided on a side surface of the module light guide plate, a diffusion part provided on a front surface of the module light guide plate and located to overlap the sheet holes, the diffusion part being configured to diffuse the auxiliary light toward the front surface, a selective transmission part provided on a back surface of the module light guide plate and located to overlap the sheet holes, the selective transmission part being configured to, among external light incident through the sheet holes, reflect external light in a visible wavelength band and allow external light in an infrared wavelength band to pass therethrough, and an optical element provided on a back surface of the selective transmission part and located to overlap the sheet holes.

The selective transmission part may have a transmittance of 5% or less in a wavelength band ranging from 380 nm to 700 nm of the external light and may have a transmittance of 95% or more in a wavelength band ranging from 900 nm to 1000 nm of the external light.

The selective transmission part may include a dichroic layer.

A width of the diffusion part may be larger than a width of the sheet hole and may be smaller than a width of the selective transmission part.

The diffusion part may have a haze value of 20% or more and 35% or less.

Other systems, methods, features and advantages will be, or will become, apparent to one with skill in the art upon examination of the following figures and detailed description. It is intended that all such additional systems, methods, features and advantages be included within this description, be within the scope of the present disclosure, and be protected by the following claims. Nothing in this section should be taken as a limitation on those claims. Further aspects and advantages are discussed below in conjunction with embodiments of the disclosure.

It is to be understood that both the foregoing general description and the following detailed description of the present disclosure are exemplary and explanatory and are intended to provide further explanation of the inventive concepts as claimed.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain principles of the disclosure. In the drawings:

FIG. 1 is a view for description of a display apparatus according to an embodiment of the present disclosure;

FIG. 2 is a view showing an example of a cross section taken along lines I-I′ and II-II′ in FIG. 1 for description of a sheet hole guide part according to a first embodiment of the present disclosure;

FIG. 3 is an enlarged view of an area K1 in FIG. 2 for description of a relationship between the sheet hole guide part, a liquid crystal panel, and a backlight sheet according to the first embodiment of the present disclosure;

FIG. 4 is a view showing an example of a cross section taken along line III-III′ in FIG. 1 according to the first embodiment of the present disclosure;

FIG. 5 shows an example for description of a cover bottom shown in FIG. 2 according to the first embodiment of the present disclosure;

FIG. 6 shows an example for description of a structure in which a backlight light guide plate is mounted on the cover bottom shown in FIG. 2 according to the first embodiment of the present disclosure;

FIG. 7 shows an example for description of a structure in which the backlight sheet is mounted on the cover bottom shown in FIG. 2 according to the first embodiment of the present disclosure;

FIG. 8 shows an example for description of a relationship between the sheet hole guide part according to the first embodiment of the present disclosure and an optical module;

FIG. 9 is a view for description of the effect of the sheet hole guide part according to the first embodiment of the present disclosure;

FIG. 10 is a view for description of a sheet hole guide part according to a second embodiment of the present disclosure;

FIG. 11 is a view for description of transmittance of the sheet hole guide part according to the second embodiment of the present disclosure depending on wavelength bands; and

FIG. 12 is a view for description of an example of a planar shape of a sheet hole guide part and a planar shape of a plurality of sheet holes according to an example of the present disclosure.

### DETAILED DESCRIPTION

Reference will now be made in detail to embodiments of the present disclosure, examples of which may be illustrated in the accompanying drawings. In the following description, when a detailed description of well-known functions or configurations related to this document is determined to unnecessarily cloud a gist of the inventive concept, the detailed description thereof will be omitted or may be briefly discussed. The progression of processing steps and/or operations described is an example; however, the sequence of steps and/or operations is not limited to that set forth herein and may be changed as is known in the art, with the exception of steps and/or operations necessarily occurring in a particular order. Like reference numerals designate like elements throughout. Names of the respective elements used in the following explanations may be selected only for convenience of writing the specification and may be thus different from those used in actual products.

Advantages and features of the present disclosure, and implementation methods thereof will be clarified through following example embodiments described with reference to the accompanying drawings. The present disclosure may, however, be embodied in different forms and should not be construed as limited to the example embodiments set forth herein. Rather, these example embodiments may be provided so that this disclosure may be sufficiently thorough and complete to assist those skilled in the art to fully understand the scope of the present disclosure. Further, the present disclosure is only defined by scopes of claims.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can.”

Hereinafter, details related to the above objects, technical configurations, and operational effects of the embodiments of the present disclosure will be clearly understood by the following detailed description with reference to the drawings, which illustrate some embodiments of the present disclosure. Here, the embodiments of the present disclosure are provided in order to allow the technical sprit of the present disclosure to be sufficiently conveyed to those skilled in the art, and thus the present disclosure may be embodied in other forms and is not limited to the embodiments described below.

In addition, the same or extremely similar elements may be designated by the same reference numerals throughout the specification. In the drawings, the lengths and thickness of layers and regions may be exaggerated for convenience. It will be understood that, when a first element is referred to as being “on” a second element, the first element may be disposed on the second element to come into contact with the second element, and a third element may be interposed between the first element and the second element.

Here, terms such as, for example, “first” and “second” are used to describe various elements and are used to distinguish one element from another element. However, the first element and the second element may be arbitrarily named according to the convenience of those skilled in the art without departing from the technical sprit of the present disclosure.

The terms used in the specification of the present disclosure are merely used in order to describe particular embodiments, and are not intended to limit the scope of the present disclosure. For example, an element described in the singular form is intended to include a plurality of elements unless the context clearly indicates otherwise. In addition, in the specification of the present disclosure, it will be further understood that the terms “comprises” and “includes” specify the presence of stated features, integers, steps, operations, elements, components, and/or combinations thereof, but do not preclude the presence or addition of one or more other features, integers, steps, operations, elements, components, and/or combinations.

Also, when an element or layer is “connected,” “coupled,” or “adhered” to another element or layer denotes that the element or layer can not only be directly connected or adhered to anotherthe other element or layer, but also be indirectly connected or adhered to anotherthe other element or layer with one or more intervening elements or layers “disposed,” or “interposed” between the elements or layers, unless otherwise specified. It should be understood to mean that elements may be so disposed to directly contact each other, or may be so disposed without directly contacting each other.

The expression of a first element, a second elements “and/or” a third element should be understood as one of the first, second and third elements or as any or all combinations of the first, second and third elements. By way of example, A, B and/or C can refer to only A; only B; only C; any or some combination of A, B, and C; or all of A, B, and C.

The term “at least one” should be understood as including any and all combinations of one or more of the associated listed items. For example, the meaning of “at least one of a first element, a second element, and a third element” encompasses the combination of all three listed elements, combinations of any two of the three elements, as well as each individual element, the first element, the second element, or the third element.

Unless otherwise defined, all terms including technical and scientific terms used herein have the same meaning as commonly understood by those skilled in the art to which the present disclosure belongs. It will be further understood that terms, such as those defined in commonly used dictionaries, should be interpreted as having a meaning that is consistent with their meaning in the context of the relevant art and should not be interpreted in an idealized or overly formal sense unless explicitly defined in the specification of the present disclosure.

Further, in the specification, the front surface of an element means one surface of the element, which is located in a direction in which an image is displayed, and the back surface means the other surface of the element, which is located in the opposite direction to the front surface.

Further, in the specification, a first direction may mean either a major axis direction or a minor axis direction in the plane of a liquid crystal panel, a second direction may mean a direction intersecting the first direction in the plane of the liquid crystal panel, and a third direction may mean a thickness direction of the liquid crystal panel intersecting the first and second directions.

Features of various embodiments of the present disclosure may be partially or overall coupled to or combined with each other, and may be variously inter-operated with each other and driven technically as those skilled in the art can sufficiently understand. Embodiments of the present disclosure may be carried out independently from each other, or may be carried out together in co-dependent relationship.

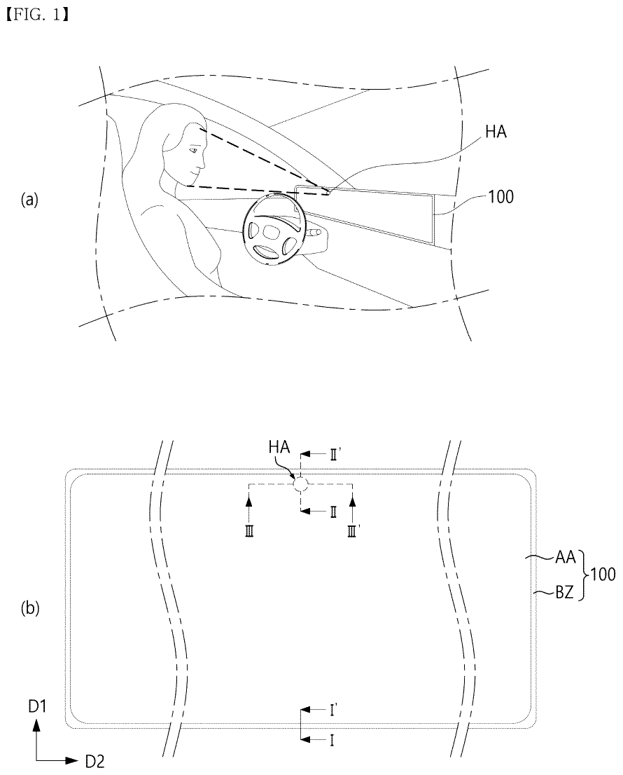

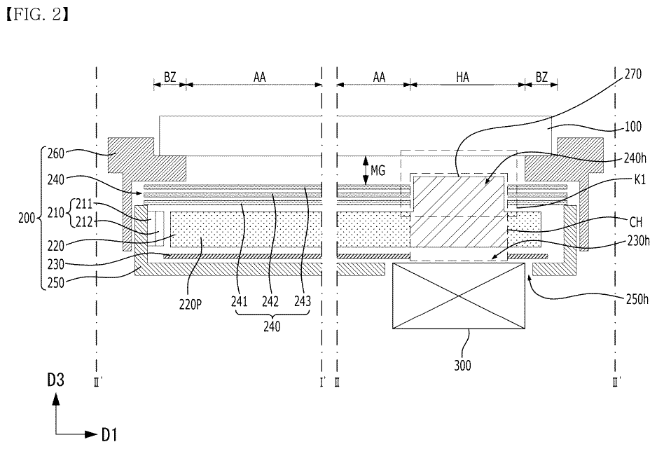

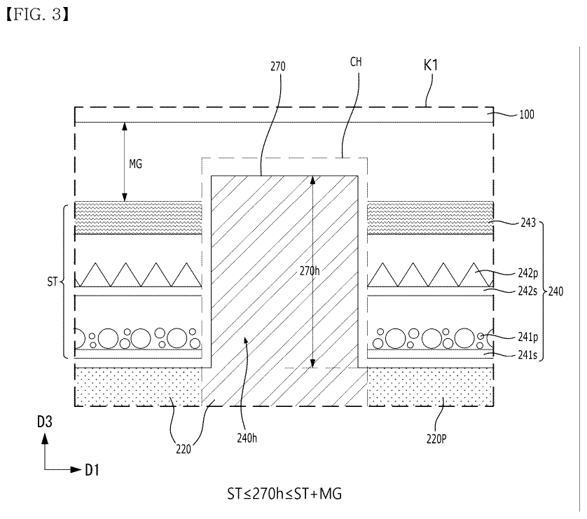

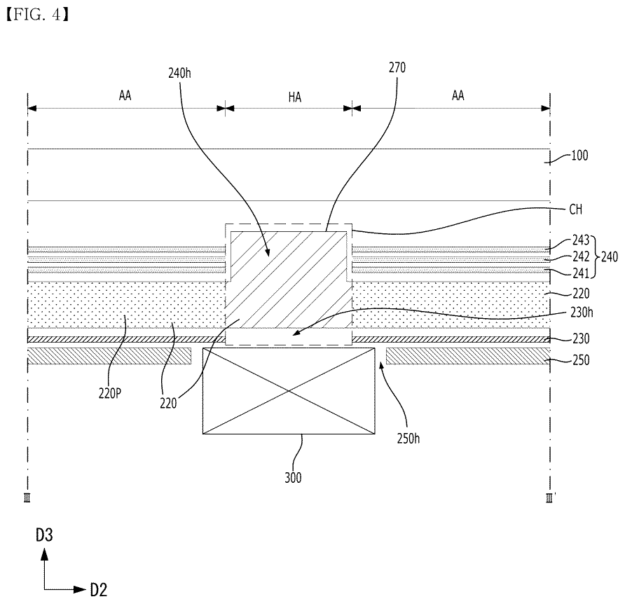

FIG. 1 is a view for description of a display apparatus according to an embodiment of the present disclosure, FIG. 2 is a view showing an example of a cross section taken along lines I-I′ and II-II′ in FIG. 1 for description of a sheet hole guide part according to a first embodiment of the present disclosure, FIG. 3 is an enlarged view of an area K1 in FIG. 2 for description of a relationship between the sheet hole guide part, a liquid crystal panel, and a backlight sheet according to the first embodiment of the present disclosure, and FIG. 4 is a view showing an example of a cross section taken along line III-III′ in FIG. 1.

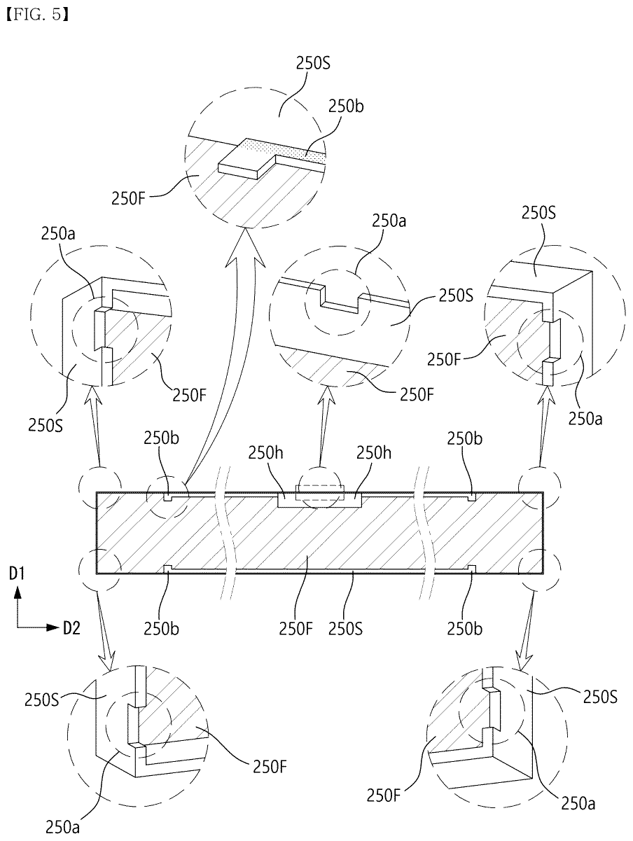

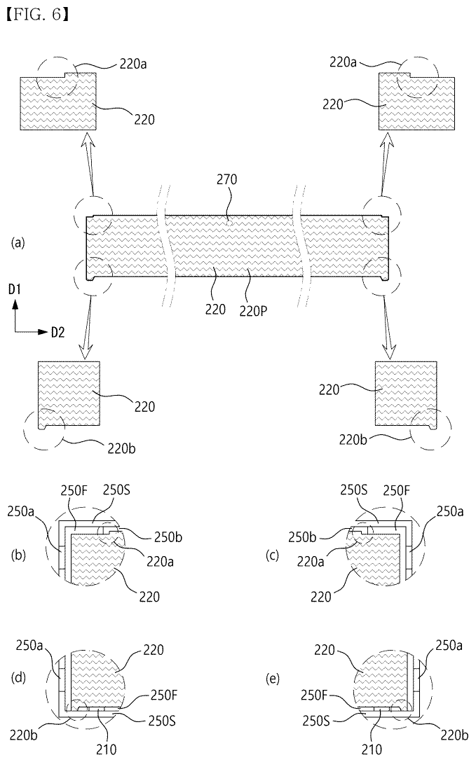

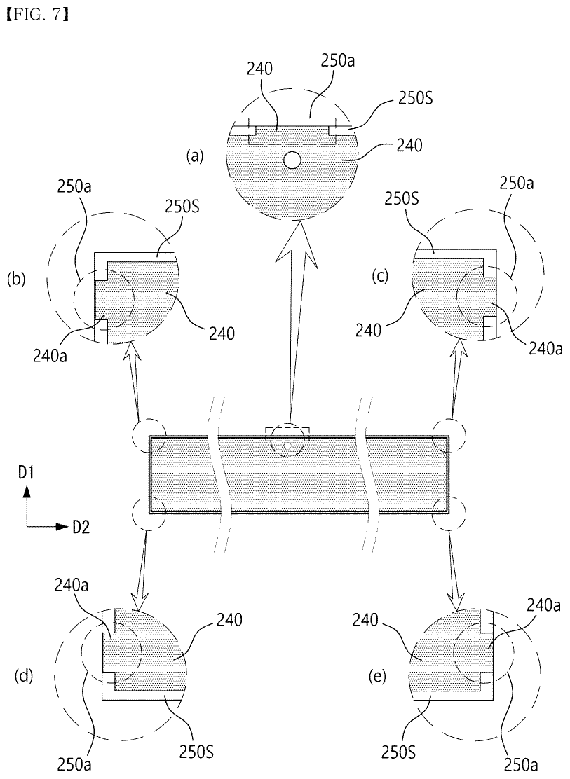

FIG. 5 shows an example for description of a cover bottom shown in FIG. 2, FIG. 6 shows an example for description of a structure in which a backlight light guide plate is mounted on the cover bottom shown in FIG. 2, and FIG. 7 shows an example for description of a structure in which the backlight sheet is mounted on the cover bottom shown in FIG. 2.

A display apparatus according to an example of the present specification may be used as a vehicle display apparatus provided on the front surface of the driver's seat of a vehicle, as shown in FIG. 1(a), and an optical module 300 provided in the display apparatus may be used to recognize, for example, the face of a user who is a vehicle driver.

However, this is an example, and the present disclosure is not necessarily limited thereto. For example, the display apparatus of the present specification may also be used in a portable display apparatus such as in a notebook or a tablet, and the optical module 300 may be used to sense a target object outside the display apparatus.

Referring to FIGS. 1 to 4, the display apparatus according to the embodiment of the present disclosure may include a liquid crystal panel 100, a backlight unit 200, and the optical module 300.

The liquid crystal panel 100 may generate an image to be provided to a user. For example, the liquid crystal panel 100 may include an active area AA having a plurality of pixel areas located therein and a bezel area BZ located outside the active area AA.

The liquid crystal panel 100 may include a liquid crystal layer overlapping the pixel areas. For example, the liquid crystal layer of the liquid crystal panel 100 may include a liquid crystal in the IPS(In-Plane Switching) mode or a liquid crystal in the TN(Twisted Nematic) mode.

For example, liquid crystals located within a partial area of the liquid crystal layer overlapping each pixel area may be rotated by a vertical electric field or a horizontal electric field formed within the corresponding pixel area through signal lines. Accordingly, in the display apparatus according to the embodiment of the present disclosure, various color images may be generated by light emitted from the active area AA of the liquid crystal panel 100.

Within the active area AA, a hole area HA may be provided at a location thereof overlapping the optical module 300. The optical module 300 may detect external light incident through the hole area HA and may sense an external target object through the hole area HA. That is, the hole area HA may function as a sensing area. The hole area HA may be an area in which a camera hole CH provided in the backlight unit 200 is projected onto the liquid crystal panel 100.

The backlight unit 200 may supply light to the liquid crystal panel 100. For example, the backlight unit 200 may include a backlight light source element 210, a backlight light guide plate 220, a backlight reflector 230, a backlight sheet 240, and a sheet hole guide part 270.

The backlight light source element 210 may supply light to the liquid crystal panel 100 through the backlight light guide plate 220. For example, the backlight light source element 210 may be located on one side surface of the backlight light guide plate 220. The liquid crystal panel 100 may be located on the front surface of the backlight light guide plate 220.

The backlight light source element 210 may include a backlight circuit board 211 and a backlight light source 212 mounted on the backlight circuit board 211. The backlight light source 212 may be a self-luminous element capable of generating and emitting light. For example, the backlight light source 212 may include an LED.

The backlight light guide plate 220 may be located between the backlight reflector 230 and the liquid crystal panel 100, and the backlight light source element 210 may be located on the side surface of the backlight light guide plate 220. The backlight light guide plate 220 may include a transparent material and may include any one of plastic, acrylic, polymethylmethacrylate (PMMA), and polycarbonate (PC).

The backlight light guide plate 220 may receive light from the backlight light source element 210, may allow the light to pass therethrough according to the principle of total internal reflection, and may emit, through refraction and scattering of light, the light in a front surface direction in which the liquid crystal panel 100 is located. To this end, the backlight light guide plate 220 may include a light guide plate pattern 220P for refraction and scattering of light.

For example, as shown in FIGS. 2 and 4, the light guide plate pattern 220P may be located at a portion of the backlight light guide plate 220, which overlaps the active area AA and does not overlap the hole area HA or the camera hole (CH), and the light guide plate pattern 220P may not be provided at a portion of the backlight light guide plate 22, which overlaps the hole area HA or the camera hole CH. Therefore, the quality of an image captured by the optical module 300 located on the back surface of the backlight unit 200, which overlaps the hole area HA or the camera hole CH, may be further improved.

The backlight light guide plate 220 may be fixed to a guide structure provided on a cover bottom 250. This structural configuration will be described later with reference to FIG. 6.

The backlight reflector 230 may be located on the back surface of the backlight light guide plate 220. The back surface of the backlight light guide plate 220 may face the front surface of the backlight reflector 230. For example, the backlight reflector 230 may include a material capable of reflecting light. For example, the backlight reflector 230 may include a metal such as aluminum (Al) or silver (Ag).

Light emitted through the back surface of the backlight light guide plate 220 may be reflected toward the liquid crystal panel 100 by the backlight reflector 230. Therefore, in the display apparatus according to the embodiment of the present disclosure, the amount of light supplied to the liquid crystal panel 100 may be increased by the backlight unit 200.

The backlight reflector 230 may have a reflector hole 230h provided in a portion thereof overlapping the hole area HA and formed to be open, and may form the camera hole CH together with a sheet hole 240h formed in the backlight sheet 240.

The backlight sheet 240 may be located between the backlight light guide plate 220 and the liquid crystal panel 100. Light supplied to the liquid crystal panel 100 through the backlight light guide plate 220 may have overall uniform brightness due to the backlight sheet 240.

For example, the backlight sheet 240 may include a diffusion sheet 241, a prism sheet 242, and a dual brightness enhancement film (DBEF) 243. For example, the backlight sheet 240 may have a laminated structure in which the diffusion sheet 241, the prism sheet 242, and the dual brightness enhancement film 243 are laminated, as shown in FIG. 3.

Specifically, as shown in FIG. 3, the diffusion sheet 241 may include diffusion particles 241p dispersed on a first base substrate 241s. The first base substrate 241s may include a transparent material. For example, the first base substrate 241s may include plastic.

The diffusion particles 241p may have various sizes. Accordingly, in the display apparatus according to the embodiment of the present disclosure, it is possible to improve uniformity of light supplied to the liquid crystal panel 100 through the backlight sheet 240. The diffusion particles 241p may be fixed on the first base substrate 241s by a transparent resin.

The prism sheet 242 may include a prism member 242p located on a second base substrate 242s. For example, the cross section of the prism member 242p may have a shape in which triangles are repeatedly arranged.

The second base substrate 242s may include a transparent material. For example, the second base substrate 242s may include plastic. The prism member 242p may include a transparent material. For example, the prism member 242p may be formed of the same material as that of the second base substrate 242s. A boundary between the second base substrate 242s and the prism member 242p may not be visually recognized. The second base substrate 242s may include the same material as that of the first base substrate 241s.

The dual brightness enhancement film 243 may be configured to include a plurality of layers and may increase the amount of light that is incident on the liquid crystal panel 100 from the backlight light guide plate 220 by utilizing polarization characteristics of light, thereby improving brightness of the liquid crystal panel 100.

The dual brightness enhancement film 243 may have a function of selectively transmitting light of a specific polarization component to the liquid crystal panel 100 and reflecting light of other polarization components so as to return the light to the backlight reflector 230. The dual brightness enhancement film 243 may also be referred to as a reflective polarizer.

Light reflected by the dual brightness enhancement film 243 may be re-reflected by the backlight reflector 230 and may be incident on the dual brightness enhancement film 243. Here, the dual brightness enhancement film 243 may increase the amount of light emitted to the liquid crystal panel 100 by repeatedly performing such reflection and re-reflection of light. In this manner, brightness of the liquid crystal panel 100 may be improved. Accordingly, the dual brightness enhancement film 243 may reduce power consumption of the backlight light source element 210 and may improve energy efficiency.

FIG. 3 shows, as an example, a case in which the backlight sheet 240 includes the diffusion sheet 241, the prism sheet 242, and the dual brightness enhancement film 243, but the present disclosure is not limited thereto. The backlight sheet 240 may include other functional sheets.

Each of these backlight sheets 240 may be fixed to the guide structure provided on the cover bottom 250. This structural configuration will be described later with reference to FIG. 7.

Each of the diffusion sheet 241, the prism sheet 242, and the dual brightness enhancement film 243 included in the backlight sheet 240 may have the sheet hole 240h provided in a portion thereof overlapping the hole area HA and formed to be open. The planar shapes of the plurality of sheet holes 240h respectively provided in the diffusion sheet 241, the prism sheet 242, and the dual brightness enhancement film 243 may be identical to each other.

The sheet hole 240h may form the camera hole CH together with the reflector hole 230h.

A plurality of sheet holes 240h may have the sheet hole guide part 270 inserted thereinto and configured to align the plurality of sheet holes 240h. After the cover bottom 250 and the like are described in more detail, the sheet hole guide part 270 will be described.

The camera hole CH may be configured to include the sheet hole 240h and the reflector hole 230h. Here, the width of the sheet hole 240h and the width of the reflector hole 230h may be substantially the same within an error range. Therefore, the width of the sheet hole 240h and the width of the reflector hole 230h may form the width of the camera hole CH.

The cover bottom 250 may include a bottom surface and side walls each protruding from an edge of the bottom surface. The bottom surface and the side walls of the cover bottom 250 may provide a space for accommodation of the backlight light source element 210, the backlight light guide plate 220, the backlight reflector 230, and the backlight sheet 240. The cover bottom 250 may include an insulating material. For example, the cover bottom 250 may include plastic.

The backlight reflector 230 may be located between the backlight light guide plate 220 and the bottom surface of the cover bottom 250. The space formed by the bottom surface and the side walls of the cover bottom 250 may accommodate therein the backlight light source element 210, the backlight light guide plate 220, the backlight reflector 230, and the backlight sheet 240.

For example, the side walls of the cover bottom 250 may surround the backlight light source element 210, the backlight light guide plate 220, the backlight reflector 230, and the backlight sheet 240. The cover bottom 250 may be provided with the guide structure (not shown) that fixes the positions of the backlight light guide plate 220 and the backlight sheet 240. The guide structure of the cover bottom 250 will be described later with reference to FIG. 5.

The backlight unit 200 may include a middle frame 260 configured to support the liquid crystal panel 100. The middle frame 260 may be coupled to the cover bottom 250. For example, the middle frame 260 may be coupled to the outer side of the side wall of the cover bottom 250.

The cover bottom 250 may have a cover hole 250h provided in a portion thereof overlapping the hole area HA, and the optical module 300 may be located in the cover hole 250h. The size of the cover hole 250h may be formed to be larger than the size of the camera hole CH.

The backlight light source element 210 may be fixed to the side wall of the cover bottom 250. For example, the backlight light source element 210 may be attached to the side wall of the cover bottom 250 by an adhesive member.

The middle frame 260 may include a mounting area extending toward a space formed between the backlight sheet 240 and the liquid crystal panel 100. For example, the mounting area of the middle frame 260 may overlap the bezel area BZ of the liquid crystal panel 100. The active area AA of the liquid crystal panel 100 may not overlap the mounting area of the middle frame 260.

The optical module 300 may detect external light incident through the hole area HA of the liquid crystal panel 100 and the camera hole CH of the backlight unit 200. The optical module 300 may be located to overlap the hole area HA, and the hole area HA may be an area in which the camera hole CH is projected onto the liquid crystal panel 100. The optical module 300 may detect external light incident through the hole area HA and the camera hole CH to sense a target object located outside the liquid crystal panel 100.

The optical module 300 may be fixed to the backlight unit 200. For example, the optical module 300 may be fixedly located on the cover bottom 250.

The sheet hole guide part 270 may be inserted into a plurality of sheet holes 240h to align the plurality of sheet holes 240h. The sheet hole guide part 270 may be integrally provided with the backlight light guide plate 220 as in the first embodiment of the present specification, or may be provided as a separate member from the backlight light guide plate 220 as in the second embodiment of the present specification.

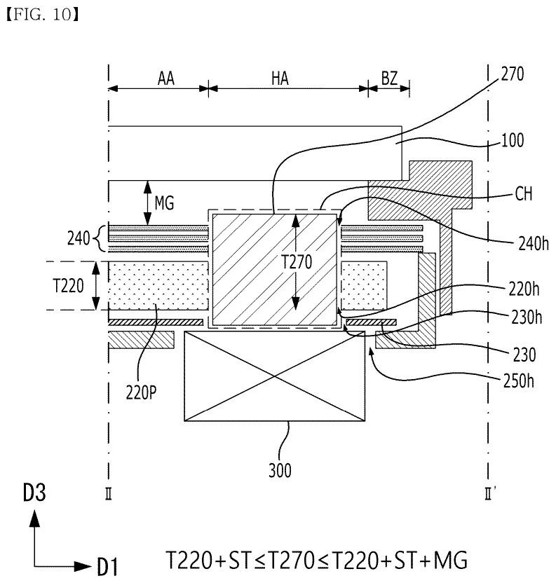

FIGS. 2 to 4 show a case in which the sheet hole guide part 270 is integrally provided with the backlight light guide plate 220 as the first embodiment. In the present specification, the first embodiment of the sheet hole guide part 270 shown in FIGS. 2 to 4 will be described first, and the second embodiment of the sheet hole guide part 270 provided separately from the backlight light guide plate 220 will be described later with reference to FIG. 10.

The sheet hole guide part 270 according to the first embodiment of the present disclosure may be integrally provided with a part of the backlight light guide plate 220, as shown in FIGS. 2 to 4, and may protrude from the backlight light guide plate 220 so as to be inserted into a plurality of sheet holes 240h.

The sheet hole guide part 270 may include a transparent material, and for example, the material of the sheet hole guide part 270 may be the same as the material of the backlight light guide plate 220. The sheet hole guide part 270 may be located to overlap a portion of the backlight light guide plate 220, which does not include the light guide plate pattern 220P. Here, since the sheet hole guide part 270 is inserted into the sheet holes 240h, the sheet hole guide part 270 may be located within the camera hole CH forming the sheet holes 240h.

The transmittance of the sheet hole guide part 270 according to the first embodiment may be the same as the transmittance of a portion of the backlight light guide plate 220, which does not include the light guide plate pattern 220P or overlaps the hole area HA or the camera hole CH.

As a result, the present disclosure may further improve the quality of an image captured by the optical module 300.

The end of the sheet hole guide part 270, which is adjacent to the liquid crystal panel 100, may be located in a separation space MG formed between the plurality of backlight sheets 240 and the liquid crystal panel 100. For example, as shown in FIGS. 2 and 3, the end of the sheet hole guide part 270 formed to protrude from the backlight light guide plate 220 may penetrate the plurality of sheet holes 240h and may be located in the separation space MG formed between the plurality of backlight sheets 240 and the liquid crystal panel 100.

Therefore, a protrusion length 270h of the sheet hole guide part 270 may be larger than a sheet thickness ST obtained by summing the thicknesses of the plurality of backlight sheets 240 and smaller than the sum of the separation space MG formed between the plurality of backlight sheets 240 and the liquid crystal panel 100 and the sheet thickness ST.

As described above, in the present disclosure, the sheet hole guide part 270 is located within the camera hole CH such that the plurality of sheet holes 240h is aligned by the sheet hole guide part 270, thereby preventing or reducing misalignment between the plurality of sheet holes 240h. Accordingly, it is possible to prevent or reduce a phenomenon in which a plurality of sheet holes 240h is visually recognized in the hole area HA of the liquid crystal panel 100.

The above-described structural configuration will be described in detail. The backlight light guide plate 220 and the backlight sheet 240 may be placed in the space within the cover bottom 250, as shown in FIGS. 5 to 7.

For example, the cover bottom 250 may have a bottom surface 250F and a side wall 250S, as shown in FIG. 5. The side wall 250S of the cover bottom 250 may have a side wall groove 250a provided therein. Here, the side wall groove 250a is formed to have a relatively low height and is coupled to the backlight sheet 240. The bottom surface 250F of the cover bottom 250 may have a cover hole 250h formed therein and a bottom protrusion 250b formed thereon and coupled to the backlight light guide plate 220.

For example, as shown in FIG. 5, the side wall grooves 250a in the cover bottom 250 may be respectively provided in the upper end and the lower end of the left and right side walls 250S of the cover bottom 250, which face each other in a second direction D2 and are provided parallel to each other in a first direction D1. The side wall groove 250a may also be provided in the upper side wall 250S adjacent to the cover hole 250h. Further, the bottom protrusions 250b may be provided on the bottom surface 250F in a state of being respectively adjacent to the upper and lower side walls 250S of the cover bottom 250.

FIG. 6(a) is a planar view of the backlight light guide plate 220, and FIG. 6(b) to 6(e) are views each showing a state in which the backlight light guide plate 220 is mounted on the cover bottom 250.

As shown in FIG. 6(a), the backlight light guide plate 220 may have light-guide-plate guide grooves 220a respectively provided in the left and right sides of the upper side surface thereof. Here, each of the light-guide-plate guide grooves 220a is recessed inwards from the side surface in the second direction D2 of the backlight light guide plate 220, thereby forming a stepped portion. Additionally, the backlight light guide plate 220 may have light-guide-plate guide protrusions 220b respectively provided on the left and right sides of the lower side surface thereof. Here, each of the light-guide-plate guide protrusions 220b protrudes outwards from the side surface in the second direction D2 of the backlight light guide plate 220.

As shown in FIGS. 6(b) and 6(c), the light-guide-plate guide grooves 220a respectively provided in the left and right sides of the upper side surface of the backlight light guide plate 220 may be respectively fixed by the bottom protrusions 250b provided on the bottom surface 250F of the cover bottom 250.

As shown in FIGS. 6(d) and 6(e), the light-guide-plate guide protrusions 220b respectively provided on the left and right sides of the lower side surface of the backlight light guide plate 220 may be provided in contact with the lower side wall 250S of the cover bottom 250. A space may be formed between the lower side surface of the backlight light guide plate 220 and the lower side wall 250S of the cover bottom 250 by the light-guide-plate guide protrusions 220b, and the backlight light source element 210 may be located in the space.

The plurality of backlight sheets 240 may be provided with sheet guides 240a each protruding outwards from each side surface, as shown in FIG. 7(a) to 7(e), and each of the sheet guides 240a may be inserted into a corresponding one of the side wall grooves 250a provided in the side wall 250S of the cover bottom 250. In this manner, the plurality of backlight sheets 240 may be fixed to the side walls 250S of the cover bottom 250.

Specifically, the sheet guides 240a may respectively protrude outwards from the upper side surface and the upper and lower ends of the left and right side surfaces of each of the plurality of backlight sheets 240. Here, as shown in FIG. 7(a), the sheet guide 240a located on the upper side surface of the backlight sheet 240 is coupled to the side wall groove 250a located in the upper side wall 250S of the cover bottom 250. As shown in FIGS. 7(b) and 7(c), the sheet guides 240a respectively located on the upper ends of the left and right side surfaces of the backlight sheet 240 are respectively coupled to the side wall grooves 250a respectively located in the upper ends of the left and right side walls 250S of the cover bottom 250. Further, as shown in FIGS. 7(d) and 7(e), the sheet guides 240a respectively located on the lower ends of the left and right side surfaces of the backlight sheet 240 are respectively coupled to the side wall grooves 250a respectively located in the lower ends of the left and right side walls 250S of the cover bottom 250.

Hereinafter, a description will be given as to a relationship between the sheet hole guide part 270 and the optical module 300 according to the present disclosure.

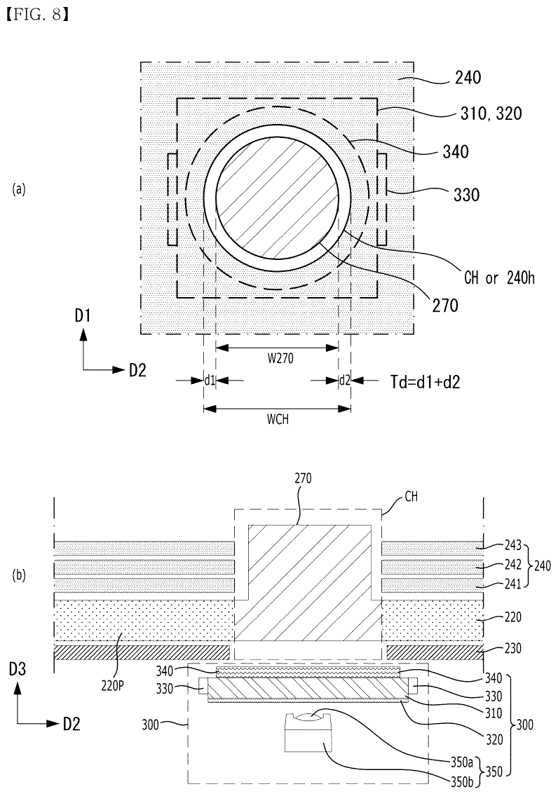

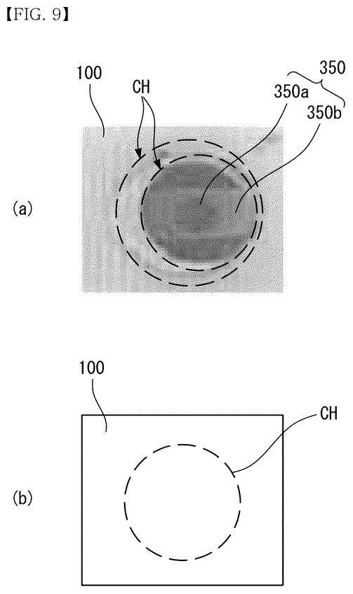

FIG. 8 shows an example for description of a relationship between the sheet hole guide part according to the first embodiment of the present disclosure and the optical module, FIG. 9 is a view for description of the effect of the sheet hole guide part according to the first embodiment of the present disclosure.

FIG. 8(a) is view showing an enlarged planar shape of the hole area HA in a state in which the liquid crystal panel 100 is removed, and FIG. 8(b) is a view schematically showing a cross section of the hole area HA in the second direction D2 in FIG. 8(a).

As shown in FIG. 8, the optical module 300 may include a module light guide plate 310, a selective transmission part 320, a module light source 330, a diffusion part 340, and an optical element 350.

The module light guide plate 310 may be provided on the back surface of the backlight light guide plate 220 and located to overlap the camera hole CH or the sheet hole 240h in a thickness direction D3. The module light source 330 may be located on the side surface of the module light guide plate 310 in a second direction D2. The module light guide plate 310 may receive auxiliary light from the module light source 330 located on the side surface thereof and may transmit the received light according to the principle of total internal reflection.

The module light guide plate 310 may include a transparent material and may include any one of glass, acrylic, polymethylmethacrylate (PMMA), and polycarbonate (PC). The module light guide plate 310 may include, for example, the same material as that of the backlight light guide plate 220 or a different material from that of the backlight light guide plate 220. The thickness of the module light guide plate 310 may be less than the thickness of the backlight light guide plate 220.

As shown in FIG. 8, the width of the module light guide plate 310 may be formed to be larger than a width WCH of the camera hole CH or the sheet hole 240h.

The selective transmission part 320 may be located on the back surface of the module light guide plate 310 in a state of overlapping the camera hole CH or the sheet hole 240h, may reflect external light in the visible wavelength band among external light incident through the camera hole CH or the sheet hole 240h, and may allow external light in the infrared wavelength band among the external light to pass therethrough.

The selective transmission part 320 may prevent or reduce the optical element 350 from being viewed through the hole area HA of the liquid crystal panel 100 by reflecting external light in the visible wavelength band, and external light in the infrared wavelength band may pass through the selective transmission part 320, thereby allowing the optical element 350 to reliably detect external light in the infrared wavelength band.

The selective transmission part 320 may have a transmittance of 5% or less in a wavelength band ranging from 380 nm to 700 nm, which corresponds to the visible wavelength band, among external light, and may have a transmittance of 90% or more in a wavelength band ranging from 900 nm to 950 nm, which corresponds to the infrared wavelength band, among external light.

As shown in FIG. 8, the width of the selective transmission part 320 may be larger than the width WCH of the camera hole CH or the sheet hole 240h. For example, the width of the selective transmission part 320 may be formed to be substantially the same as the width of the module light guide plate 310.

The selective transmission part 320 may include, for example, a dichroic layer that reflects light in the visible wavelength band and allows light in the infrared wavelength band to pass therethrough. The dichroic layer included in the selective transmission part 320 may include a dielectric material and may include a plurality of layers having different refractive indices. Specifically, the selective transmission part 320 may include at least one of silicon oxide (SiO₂), titanium oxide (TiO₂), or aluminum oxide (Al₂O₃).

The diffusion part 340 may be located on the front surface of the module light guide plate 310 in a state of overlapping the camera hole CH or the sheet hole 240h and may diffuse auxiliary light toward the front surface. The diffusion part 340 may refract and scatter the auxiliary light traveling inside the module light guide plate 310, thereby allowing the auxiliary light to be diffused toward the hole area HA of the liquid crystal panel 100 through the inside of the camera hole CH.

The width W340 of the diffusion part 340 may be larger than the width WCH of the camera hole CH or the sheet hole 240h and may be smaller than the width of the module light guide plate 310.
planar shapes of the plurality of sheet holes 240h are correspond to each other, and the planar shape of the diffusion part 340 may correspond to the planar shape of the camera hole CH or the sheet hole 240h, as shown in FIG. 8(a). Therefore, when the planar shape of the camera hole CH or the sheet hole 240h has a shape such as a circular shape, an elliptical shape, or a square shape, the planar shape of the diffusion part 340 may also have a shape such as a circular shape, an elliptical shape, or a square shape depending on the planar shape of the camera hole CH or the sheet hole 240h.

The diffusion part 340 may have unevenness including a concave shape or a convex shape directly formed on the front surface of the module light guide plate 310. Alternatively, a diffusion film having unevenness including a concave shape or a convex shape may be attached to the front surface of the module light guide plate 310.

As described above, the width W340 of the diffusion part 340 is formed to be larger than the width WCH of the camera hole CH or the sheet hole 240h and smaller than the width of the module light guide plate 310.

A haze value of the diffusion part 340 may be 25% or more and 35% or less. Accordingly, the quality of an image captured by the optical element 350 may be appropriately secured while the auxiliary light is diffused toward the camera hole CH by the diffusion part 340.

The module light sources 330 may be respectively located on the side surfaces of the module light guide plate 310 and may allow auxiliary light to be incident on the module light guide plate 310. The auxiliary light incident on the module light guide plate 310 from the module light source 330 may be reflected, refracted, and scattered by the selective transmission part 320 and the diffusion part 340 and then may be emitted toward the camera hole CH.

Each of the module light sources 330 may be a self-luminous element capable of generating and emitting light. For example, each of the module light sources 330 may include an LED. Each of the module light sources 330 may be the same element as that of the backlight light source 212. Each of the module light sources 330 may be connected to a corresponding one of module circuit boards (not shown in FIG. 4) each configured to control on/off of the module light source. Brightness of the auxiliary light generated from each of the module light sources 330 may be adjusted depending on a brightness level displayed in the hole area HA of the liquid crystal panel 100.

The module light sources 330 may be turned on/off, simultaneously. The module light sources 330 may be driven simultaneously with the backlight light source 212. For example, the liquid crystal panel 100 may generate an image using light emitted from the backlight light source element 210 and light emitted from the module light sources 330. That is, in the present disclosure, when the liquid crystal panel 100 generates an image, light may be supplied to the hole area HA of the liquid crystal panel 100 by the module light sources 330.

The optical element 350 may be located on the back surface of the selective transmission part 320 in a state of overlapping the camera hole CH or the sheet hole 240h. The optical element 350 may include an element capable of detecting external light, and may include a lens part 350a on which external light is incident and a body part 350b on which the lens part 350a is mounted.

The optical element 350 may include an IR sensor. However, the present disclosure is not limited thereto, and the optical element 350 may include at least one of a motion sensor, an illuminance sensor, or an ultrasonic sensor.

As shown in FIG. 8, a ratio of the width WCH of the plurality of sheet holes 240h to the width W270 of the sheet hole guide part 270 may range from 1:0.94 to 1:0.99. In addition, the plurality of sheet holes 240h and the sheet hole guide part 270 may be spaced apart from each other by a first interval Td.

A ratio of the width WCH of the plurality of sheet holes 240h to the first interval Td may range from 1:0.04 to 1:0.01. Here, the first interval Td may be an interval obtained by summing d1 and d2 each indicating a separation distance between the sheet hole 240h and the sheet hole guide part 270 in the second direction D2.

As described above, in the present disclosure, misalignment between the sheet holes 240h may be maximally reduced, and a process of inserting the sheet hole guide part 270 into the respective sheet holes 240h may be easily performed.

In a case where the sheet hole guide part 270 of the present disclosure is not provided, as shown in FIGS. 5 to 7, even if a plurality of backlight sheets 240 is fixed to the cover bottom 250, the length of each of the backlight sheets 240 in the second direction D2 is significantly larger than the width WCH of each of the sheet holes 240h, coefficients of thermal expansion of the respective backlight sheets 240 are different from each other, and the positions of the respective sheet holes 240h may vary depending on an internal temperature change and a process error of the display apparatus. As a result, the sheet holes 240h are not aligned with each other and as such, as shown in FIG. 9(a), a plurality of camera holes CH may appear and overlap each other on the screen (front of screen (FOS)) of the liquid crystal panel 100.

However, as in the present disclosure, when the display apparatus includes the sheet hole guide part 270, the respective sheet holes 240h may be aligned in a row by the sheet hole guide part 270. Accordingly, as shown in FIG. 9(b), misalignment between the sheet holes 240h may be prevented or reduced, and only one sheet hole 240h is visually recognized, thereby further improving the screen (FOS) characteristics of the liquid crystal panel 100.

In addition, unlike the structural configuration shown in FIG. 8, the optical module 300 may be provided with only the optical element 350. In this case, when an image is displayed in the active area AA of the liquid crystal panel 100, as shown in FIG. 9(a), the hole area HA appears dark, and a dark portion may be visually recognized in the image of the liquid crystal panel 100. Accordingly, the lens part 350a and the body part 350b of the optical element 350 may be visually recognized by a user through the hole area HA.

However, as shown in FIG. 8, according to the present disclosure, when the optical module 300 includes the module light guide plate 310, the selective transmission part 320, the module light source 330, and the diffusion part 340, light in the visible spectrum is reflected. In this manner, as shown in FIG. 9(b), visibility of the optical element 350 in the hole area HA of the liquid crystal panel 100 may be maximally reduced, and a brightness difference between the active area AA and the hole area HA is maximally reduced, thereby making it possible to remove the dark portion in which the hole area HA in FIG. 9(a) appears dark. Accordingly, the present disclosure may improve the image quality (FOS) characteristics of an image displayed on the liquid crystal panel 100.

Here, a description has been given as to the first embodiment in which the sheet hole guide part 270 of the present disclosure is integrally provided with a part of the backlight light guide plate 220 and protrudes from the backlight light guide plate 220 so as to be inserted into a plurality of sheet holes 240h.

However, the present disclosure is not limited thereto, and the sheet hole guide part 270 may be provided separately from the backlight light guide plate 220. This structural configuration of the sheet hole guide part 270 will be described below.

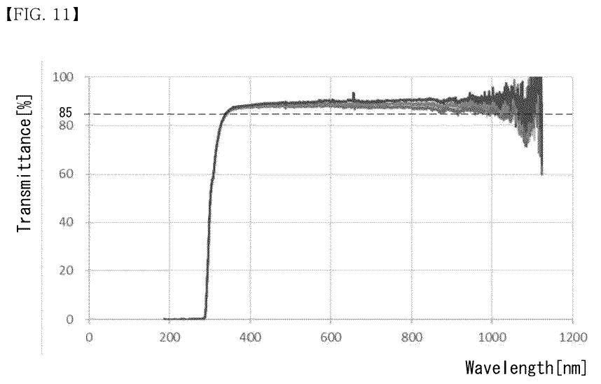

FIG. 10 is a view for description of a sheet hole guide part according to a second embodiment of the present disclosure, and FIG. 11 is a view for description of transmittance of the sheet hole guide part according to the second embodiment of the present disclosure depending on a wavelength band.

As shown in FIG. 10, the backlight light guide plate 220 may include a light guide hole 220h in a portion thereof overlapping a plurality of sheet holes 240h. That is, the backlight light guide plate 220 may include the light guide plate hole 220h in the portion where the camera hole CH formed by the sheet hole 240h and the reflector hole 230h overlap.

The sheet hole guide part 270 according to the second embodiment of the present disclosure may be provided separately from the backlight light guide plate 220 and may be inserted into a plurality of sheet holes 240h and the light guide plate hole 220h. Here, the backlight light guide plate 220 may include the light guide plate pattern 220P, and the sheet hole guide part 270 inserted into the camera hole CH may not include the light guide plate pattern 220P.

The end of the sheet hole guide part 270 according to the second embodiment, which is located adjacent to the liquid crystal panel 100, may be located in the separation space MG formed between the plurality of backlight sheets 240 and the liquid crystal panel 100.

To this end, a thickness T270 of the sheet hole guide part 270 may be larger than a sum thickness (T220+ST) obtained by summing the sheet thickness (ST, refer to FIG. 3) of the plurality of backlight sheets 240 and the thickness T220 of the backlight light guide plate 220 and may be smaller than the sum (T220+ST+MG) of the separation space MG formed between the plurality of backlight sheets 240 and the liquid crystal panel 100 and the sum thickness (T220+ST).

For example, as shown in FIG. 10, the sheet hole guide part 270 may be inserted into each of the reflector hole 230h, the light guide plate hole 220h, and the plurality of sheet holes 240h, and the end of the sheet hole guide part 270, which is located adjacent to the liquid crystal panel 100, may be located in the separation space MG which is a space formed between the plurality of backlight sheets 240 and the liquid crystal panel 100.

The sheet hole guide part 270 according to the second embodiment of the present disclosure may include a material identical to or different from a material of the backlight light guide plate 220. For example, the sheet hole guide part 270 may include any one of plastic, acrylic, polymethylmethacrylate (PMMA), and polycarbonate (PC).

In addition, in the second embodiment, similarly to the first embodiment, the ratio of the width WCH of the plurality of sheet holes 240h to the width W270 of the sheet hole guide part 270 may range from 1:0.94 to 1:0.99. In addition, the plurality of sheet holes 240 h and the sheet hole guide part 270 may be spaced apart from each other by the first interval, and the ratio of the width WCH of the plurality of sheet holes 240 h to the first interval Td may range from 1:0.04 to 1:0.01.

As shown in FIG. 11, the transmittance of the sheet hole guide part 270 according to the second embodiment may be 85% or more in a wavelength band ranging from 400 nm to 950 nm such that light in the visible spectrum may be transmitted through the sheet hole guide part 270. Accordingly, the quality of an image captured by the optical module 300 may be reliably maintained.

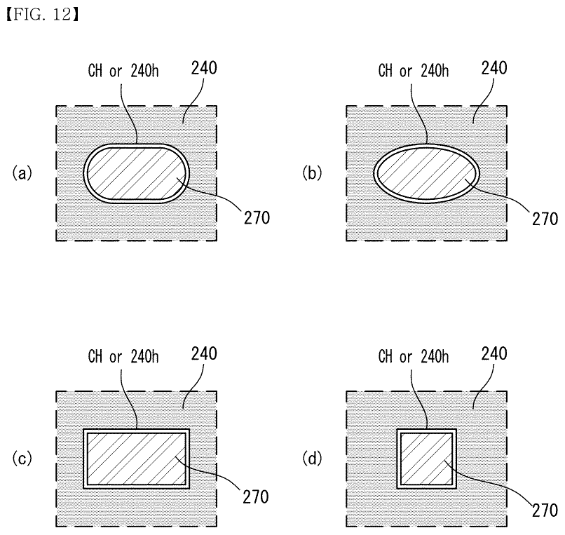

In addition, as shown in FIG. 12(a) to 12(d), the sheet hole guide part 270 may have a planar shape corresponding to a planar shape of a plurality of sheet holes 240h or the camera hole CH.

As shown in FIG. 12(a) to 12(d), when the planar shape of the plurality of sheet holes 240h or the camera hole CH is an oval shape, a square shape, or the like, the planar shape of the sheet hole guide part 270 may also be an oval shape, a square shape, or the like.

As described above, according to one embodiment of the present disclosure, the sheet hole guide part 270 inserted into the plurality of sheet holes 240h is provided so as to solve a problem in which a boundary line of the camera hole CH in the hole area HA appears as a plurality of boundary lines in a state of overlapping each other on the screen of the liquid crystal panel 100 and the boundary lines are visually recognized by a user.

In addition, according to one embodiment of the present disclosure, visibility of the optical element in the hole area HA of the liquid crystal panel 100 may be maximally reduced by providing the optical module 300 including the selective transmission part.

In addition, according to one embodiment of the present disclosure, when an image is displayed on the liquid crystal panel 100, a brightness difference between the active area AA and the hole area HA may be maximally reduced by providing the optical module 300 including the module light guide plate and the diffusion part, thereby improving image quality characteristics of the image displayed on the liquid crystal panel 100.

As is apparent from the above description, a display apparatus according to one embodiment of the present disclosure includes a sheet hole guide part inserted into a plurality of sheet holes, thereby solving a problem in which a boundary line of a camera hole in a hole area appears as a plurality of boundary lines in a state of overlapping each other on the screen of a liquid crystal panel and the boundary lines are visually recognized by a user.

Additionally, according to one embodiment of the present disclosure, an optical module includes a selective transmission part, thereby maximally reducing visibility of an optical element in the hole area of the liquid crystal panel.

Furthermore, according to one embodiment of the present disclosure, since the optical module includes a module light guide plate and a diffusion part, a brightness difference between an active area and the hole area is minimized or reduced when an image is displayed on the liquid crystal panel, thereby improving image quality characteristics of the image displayed on the liquid crystal panel.

It will be apparent to those skilled in the art that various modifications and variations can be made in the display apparatus of the present disclosure without departing from the technical idea or scope of the disclosure. Thus, it is intended that the present disclosure cover the modifications and variations of this disclosure provided they come within the scope of the appended claims and their equivalents. Also disclosed herein are a number of examples according to the following numbered clauses:
1. A display apparatus comprising:
   a backlight unit (200) comprising a backlight light guide plate (220), a plurality of backlight sheets (240), and a backlight light source element (210), the plurality of backlight sheets (240) located on a front surface of the backlight light guide plate (220) and the plurality of backlight sheets (240) having a plurality of sheet holes (240h) respectively, and the backlight light source element (210) configured to emit light to the backlight light guide plate (220);
   a liquid crystal panel (100) located on a front surface of the backlight unit (200); and
   an optical module (300) located on a back surface of the backlight unit (200) and the optical module (300) overlapped with the plurality of sheet holes (240h), the optical module (300) being configured to detect external light incident through the sheet holes (240h),
   wherein a sheet hole guide part (270) configured to align the plurality of sheet holes (240h) is inserted into the plurality of sheet holes (240h).
2. The display apparatus in clause 1, wherein the sheet hole guide part (270) has an end adjacent to the liquid crystal panel (100), the end being located in a separation space (MG) formed between the plurality of backlight sheets (240) and the liquid crystal panel (100).
3. The display apparatus in clause 1, wherein planar shapes of the plurality of sheet holes (240h) correspond to each other, and the sheet hole guide part (270) has a planar shape corresponding to the planar shape of each of the plurality of sheet holes (240h).
4. The display apparatus in clause 1, wherein the sheet hole guide part (270) is integrally provided with a part of the backlight light guide plate (220) and is formed to protrude from the backlight light guide plate (220) so as to be inserted into the plurality of sheet holes (240h).
5. The display apparatus in clause 1, wherein the backlight light guide plate (220) includes a light guide plate pattern (220P) configured to one of: refract and diffuse the light incident from the backlight light source element (210) in a predetermined direction, and the light guide plate pattern (220P) is not provided at a portion of the backlight light guide plate (220), the portion that is overlapping the sheet hole guide part (270).
6. The display apparatus in clause 1, wherein a protrusion length (270 h) of the sheet hole guide part (270) is larger than a sheet thickness obtained by summing thicknesses of the plurality of backlight sheets (240) and is smaller than the sum of a separation space (MG) formed between the plurality of backlight sheets (240) and the liquid crystal panel (100) and the sheet thickness (ST).
7. The display apparatus in clause 1, wherein the sheet hole guide part (270) is formed of a material identical to a material of the backlight light guide plate (220).
8. A display apparatus comprising:
   a backlight unit (200) comprising a backlight light guide plate (220), a plurality of backlight sheets (240), and a backlight light source element (210), the plurality of backlight sheets (240) located on a front surface of the backlight light guide plate (220) and the plurality of backlight sheets (240) having a plurality of sheet holes (240h) respectively, and the backlight light source element (210) configured to emit light to the backlight light guide plate (220);
   a liquid crystal panel (100) located on a front surface of the backlight unit (200); and
   an optical module (300) located on a back surface of the backlight unit (200) and the optical module (300) overlapped with the plurality of sheet holes (240h), the optical module (300) being configured to detect external light incident through the sheet holes (240h),
wherein the backlight light guide plate (220) includes a light guide plate hole (220h) formed in a portion where the plurality of sheet holes (240h) overlap,
   wherein a sheet hole guide part (270) configured to align the plurality of sheet holes (240h) is inserted into the plurality of sheet holes (240h) and the light guide plate hole (220h).
9. The display apparatus in clause 9, wherein the backlight light guide plate (220) includes a light guide plate pattern (220P) configured to one of: refract and diffuse the light incident from the backlight light source element (210) in a predetermined direction, and the sheet hole guide part (270) does not include the light guide plate pattern (220p).
10. The display apparatus in clause 1, wherein the sheet hole guide part (270) has a transmittance of at least 85% in a wavelength band ranging from 400 nm to 950 nm.
11. The display apparatus in clause 9, wherein a thickness of the sheet hole guide part (270) is larger than a sum thickness of a sheet thickness obtained by summing thicknesses of the plurality of backlight sheets (240) and a thickness of the backlight light guide plate (220) and is smaller than a sum of a separation space (MG) formed between the plurality of backlight sheets (240) and the liquid crystal panel (100) and the sum thickness.
12. The display apparatus in clause 9, wherein the sheet hole guide part (270) is formed of a material that is one of: identical to and different from a material of the backlight light guide plate (220).
13. The display apparatus in one of clauses 1 and 9, wherein a ratio of a width of the plurality of sheet holes (240h) to a width of the sheet hole guide part (270) ranges from 1:0.94 to 1:0.99.
14. The display apparatus in one of clauses 1 and 9, wherein the plurality of sheet holes (240h) and the sheet hole guide part (270) is spaced apart from each other by a first interval (Td), and a ratio of a width of the plurality of sheet holes (240h) to the first interval (Td) may range from 1:0.04 to 1:0.01.
15. The display apparatus in one of clauses 1 and 9,
wherein the optical module (300) includes:
a module light guide plate (310) provided on a back surface of the backlight light guide plate (220) and located to overlap the sheet holes (240h), the module light guide plate (310) being configured to guide auxiliary light received from a module light source (330) provided on a side surface of the module light guide plate (310),
a diffusion part (340) provided on a front surface of the module light guide plate (310) and located to overlap the sheet holes (240h), the diffusion part (340) being configured to diffuse the auxiliary light toward the front surface,
a selective transmission part (320) provided on a back surface of the module light guide plate (310) and located to overlap the sheet holes (240h), the selective transmission part (320) being configured to, among external light incident through the sheet holes (240h), reflect external light in a visible wavelength band and allow external light in an infrared wavelength band to pass therethrough,
and an optical element (350) provided on a back surface of the selective transmission part (320) and located to overlap the sheet holes (240h).
16. The display apparatus in one of clauses 1 and 9, wherein the selective transmission part (320) has a transmittance of maximum 5% in a fhas a transmittance of at least 95% in a wavelength band ranging from 900 nm to 1000 nm of the external light.
17. The display apparatus in one of clauses 1 and 9, wherein the selective transmission part (320) includes a dichroic layer.
18. The display apparatus in one of clauses 1 and 9, wherein a width of the diffusion part (340) is larger than a width of the sheet hole (240h) and is smaller than a width of the selective transmission part (320).
19. The display apparatus in one of clauses 1 and 9, wherein the diffusion part (340) has a haze value between 20% and 35%.

What is claimed is:

1. A display apparatus, comprising:
a backlight unit comprising a backlight light guide plate, a plurality of backlight sheets, and a backlight light source element, the plurality of backlight sheets located on a front surface of the backlight light guide plate and the plurality of backlight sheets having a plurality of sheet holes respectively, and the backlight light source element configured to emit light to the backlight light guide plate;
a liquid crystal panel located on a front surface of the backlight unit; and
an optical module located on a back surface of the backlight unit and the optical module overlapped with the plurality of sheet holes, the optical module being configured to detect external light incident through the sheet holes,
wherein a sheet hole guide part configured to align the plurality of sheet holes is inserted into the plurality of sheet holes.

2. The display apparatus according to claim 1, wherein the sheet hole guide part has an end adjacent to the liquid crystal panel, the end being located in a separation space formed between the plurality of backlight sheets and the liquid crystal panel.

3. The display apparatus according to claim 1, wherein planar shapes of the plurality of sheet holes are correspond to each other, and
wherein the sheet hole guide part has a planar shape corresponding to the planar shape of each of the plurality of sheet holes.

4. The display apparatus according to claim 1, wherein the sheet hole guide part is integrally provided with a part of the backlight light guide plate, and the sheet hole guide part is formed to protrude from the backlight light guide plate so as to be inserted into the plurality of sheet holes.

5. The display apparatus according to claim 4, wherein the backlight light guide plate comprises a light guide plate pattern, the light guide plate pattern is configured to refract or diffuse the light incident from the backlight light source element in a predetermined direction, and
wherein the light guide plate pattern is not provided at a portion of the backlight light guide plate, the portion overlapping the sheet hole guide part, but the light guide plate pattern is provided at another portion of the backlight light guide plate, the another portion not overlapping the sheet hole guide part.

6. The display apparatus according to claim 4, wherein the sheet hole guide part has a transmittance equal to a transmittance of a portion of the backlight light guide plate, the portion overlapping the sheet holes.

7. The display apparatus according to claim 4, wherein a protrusion length of the sheet hole guide part is larger than a sheet thickness obtained by summing thicknesses of the plurality of backlight sheets and the protrusion length of the sheet hole guide part is smaller than a sum of a separation space formed between the plurality of backlight sheets and the liquid crystal panel and the sheet thickness.

8. The display apparatus according to claim 4, wherein the sheet hole guide part is formed of a material identical to a material of the backlight light guide plate.

9. The display apparatus according to claim 1, wherein the backlight light guide plate comprises a light guide plate hole formed in a portion where the plurality of sheet holes overlap, and
wherein the sheet hole guide part is inserted into the plurality of sheet holes and the light guide plate hole.

10. The display apparatus according to claim 9, wherein the backlight light guide plate comprises a light guide plate pattern, the light guide plate pattern configured to refract or diffuse the light incident from the backlight light source element in a predetermined direction, and
wherein the sheet hole guide part does not comprise the light guide plate pattern.

11. The display apparatus according to claim 9, wherein the sheet hole guide part has a transmittance of equal to or more than 85% in a wavelength band ranging from 400 nm to 950 nm.

12. The display apparatus according to claim 9, wherein a thickness of the sheet hole guide part is larger than a sum thickness of a sheet thickness obtained by summing thicknesses of the plurality of backlight sheets and a thickness of the backlight light guide plate, and the thickness of the sheet hole guide part is smaller than a sum of a separation space formed between the plurality of backlight sheets and the liquid crystal panel and the sum thickness.

13. The display apparatus according to claim 9, wherein the sheet hole guide part is formed of a material identical to or different from a material of the backlight light guide plate and the sheet hole guide part comprises any one of glass, plastic, acrylic, polymethylmethacrylate PMMA, and polycarbonate PC.

14. The display apparatus according to claim 1, wherein a ratio of a width of the plurality of sheet holes to a width of the sheet hole guide part ranges from 1:0.94 to 1:0.99.

15. The display apparatus according to claim 1, wherein the plurality of sheet holes and the sheet hole guide part are spaced apart from each other by a first interval, and
wherein a ratio of a width of the plurality of sheet holes to the first interval ranges from 1:0.04 to 1:0.01.

16. The display apparatus according to claim 1, wherein the optical module comprises:
a module light guide plate provided on a back surface of the backlight light guide plate and the module light guide plate located to overlap the sheet holes, the module light guide plate being configured to guide auxiliary light received from a module light source provided on a side surface of the module light guide plate;
a diffusion part provided on a front surface of the module light guide plate and the diffusion part located to overlap the sheet holes, the diffusion part being configured to diffuse the auxiliary light toward the front surface;
a selective transmission part provided on a back surface of the module light guide plate and the selective transmission part located to overlap the sheet holes, the selective transmission part being configured to, among external light incident through the sheet holes, reflect external light in a visible wavelength band and the selective transmission part being configured to allow external light in an infrared wavelength band to pass through the selective transmission part; and
an optical element provided on a back surface of the selective transmission part and the optical element located to overlap the sheet holes.

17. The display apparatus according to claim 16, wherein the selective transmission part has a transmittance of equal to or less than 5% in a wavelength band ranging from 380 nm to 700 nm of the external light and has a transmittance of equal to or more than 95% in a wavelength band ranging from 900 nm to 1000 nm of the external light.

18. The display apparatus according to claim 16, wherein the selective transmission part comprises a dichroic layer.

19. The display apparatus according to claim 16, wherein a width of the diffusion part is larger than a width of the sheet holes and the width of the diffusion part is smaller than a width of the selective transmission part.

20. The display apparatus according to claim 16, wherein the diffusion part has a haze value of equal to or more than 20% and equal to or less than 35%.
